(19) United States
(12) Patent Application Publication
(10) Pub. No.: US 2016/0142874 A1
(43) Pub. Date: May 19, 2016

(54) APPARATUS AND METHOD FOR RECOGNIZING NEARBY DEVICE USING DISTANCE AND INTIMACY

(71) Applicant: Electronics and Telecommunications Research Institute, Daejeon-city (KR)

(72) Inventors: Joon-Young JUNG, Daejeon (KR); Dong-Oh KANG, Daejeon (KR); Chang-Seok BAE, Daejeon (KR); Jang-Ho CHOI, Incheon (KR)

(21) Appl. No.: 14/591,430

(22) Filed: Jan. 7, 2015

(30) Foreign Application Priority Data
Nov. 19, 2014 (KR) 10-2014-0161465

(51) Int. Cl. H04W 4/02; H04W 8/00

(52) U.S. Cl. CPC H04W 4/023; H04W 8/005

(57) ABSTRACT

Disclosed herein is an apparatus and method for recognizing a nearby device, which measure distances between devices and calculate intimacies between the devices, thus notifying a user of the distances to and intimacies with nearby devices. The apparatus includes a distance determination module unit for determining distances to a plurality of nearby devices based on signals for distance determination, received from the respective nearby devices. A zone determination module unit determines zones to which the respective nearby devices belong, among multiple zones, depending on the distances to the respective nearby devices. A nearby device recognition module unit recognizes the nearby devices using received information of the nearby devices. An intimacy determination module unit determines intimacies with the nearby devices, based on previously stored information required for intimacy determination. A user interface unit displays results of distance determination and intimacy determination to a user.

### CROSS REFERENCE TO RELATED APPLICATION

This application claims priority to and the benefit of Korean Patent Application No. 10-2014-0161465, filed Nov. 19, 2014, which is hereby incorporated by reference in its entirety into this application.

### BACKGROUND OF THE INVENTION

1. Technical Field

The present invention relates generally to an apparatus and method for recognizing a nearby device using distance and intimacy and, more particularly, to an apparatus and method that can classify nearby devices depending on distances by measuring distances to the nearby devices and that can classify nearby devices depending on intimacies by using intimacies with the nearby devices, upon recognizing nearby devices.

2. Description of the Related Art

Methods of allowing a specific device to recognize and display nearby devices include Apple's AirDrop or the like. Apple's AirDrop refers to an interface for recognizing nearby Media Access Control (MAC) devices using a wireless device (e.g., a Wi-Fi device), and displaying nearby devices that are within a distance of about 9 meters (30 ft). Since Apple's AirDrop merely determines, via use of a wireless device, whether a relevant nearby device falls within the range of about 9 meters, there is a limitation in that such a determination service is provided for various distances.

Currently, methods of determining distances between devices include a method using signal intensities, a method using the transmission rates of signals, a method using a difference between the transmission rates of two signals, etc.

The method using signal intensities uses various wireless signals such as Wireless Local Area Network (WLAN), Bluetooth, ZigBee, and Radio Frequency Identification (RFID) signals, and has a relatively high error rate due to the interference, diffraction and reflection of surrounding wireless signals, thus making it difficult to precisely determine distances. However, since such a method has the advantage of being implemented at low costs, it is widely used for distance measurement.

The method using the transmission rates of signals is a method for measuring a distance using a difference between a time at which a signal transmitting device transmits a signal and a time at which a signal receiving device receives a signal. This method is a method using a signal transfer model and may measure a distance using a wireless signal transfer model as long as time synchronization is precisely performed. However, there is a difficulty in exactly synchronizing times between two devices.

The method using a difference between the transmission rates of two signals is configured such that a transmitting device simultaneously transmits two types of signals having a large difference between transmission rates, and such that a receiving device measures a distance between the transmitting device and the receiving device using both a difference between times at which the two signals were received and respective signal transfer models. Such a method is capable of measuring distance highly precisely, but a device capable of simultaneously transmitting and receiving two types of signals is required, and thus additional hardware is required. Further, since an ultrasonic signal that is used as one of the two types of signals has a short measurement distance, there is a limitation in distance that can be measured.

Furthermore, with the development of technology such as Machine-To-Machine (M2M) and Internet of Things (IoT), it is predicted that more and more devices will be present around a user device, and a user must determine to which nearby device he or she will connect among multiple nearby devices. It is predicted that the user will want to connect to a device having high intimacy with the user device rather than any unknown devices among multiple nearby devices. However, information about the degree of intimacy of the device, which is recognized as a nearby device, with the user device is not provided.

As related preceding technology, U.S. Patent Application Publication No. 2014-0225931 (entitled “Adaptive Screen Interfaces Based on Viewing Distance”) discloses technology that determines a distance between a display device and a user and the characteristics of the user upon interaction between the display device and the user, and which can modify content on the display device and the type of commands.

As another related preceding technology, Korean Patent Application Publication No. 2007-0120358 (entitled “Display apparatus and method responsive to distance”) discloses technology for determining a distance between a user and a screen and then realizing optimal screen configuration.

### SUMMARY OF THE INVENTION

Accordingly, the present invention has been made keeping in mind the above problems occurring in the prior art, and an object of the present invention is to provide an apparatus and method that measure distances between devices and calculate intimacies between the devices, thus notifying a user of the distances to and intimacies with nearby devices.

In accordance with an aspect of the present invention to accomplish the above object, there is provided an apparatus for recognizing a nearby device using distance and intimacy, including a distance determination module unit for determining distances to a plurality of nearby devices based on signals for distance determination, received from the respective nearby devices; a zone determination module unit for determining zones to which the respective nearby devices belong, among multiple zones, depending on the distances to the respective nearby devices determined by the distance determination module unit; a nearby device recognition module unit for recognizing the nearby devices using received information of the nearby devices; an intimacy determination module unit for determining intimacies with the nearby devices recognized by the nearby device recognition module unit, based on previously stored information required for intimacy determination; and a user interface unit for displaying results of distance determination and intimacy determination to a user.

The user interface unit may classify ranges of distances to the respective nearby devices into multiple zones and represent the nearby devices by icons or text in the determined zones.

The user interface unit may represent the nearby devices by different colors or by different sizes depending on the determined intimacies.

The multiple zones may be arranged to cover ranges of different radiuses depending on distances from the nearby device recognition apparatus.

The distance determination module unit may periodically or non-periodically receive signals for distance determination from the plurality of nearby devices.

The received information of the nearby devices may include a name of an owner of each nearby device, a type of the nearby device, and an identification number of the nearby device.

The information required for intimacy determination may include family relationship information or friend relationship information between an owner of the nearby device recognition apparatus and an owner of each nearby device, and communication history information between the nearby device recognition apparatus and the nearby device.

The apparatus may further include an intimacy database (DB) for storing the information required for intimacy determination.

In accordance with another aspect of the present invention to accomplish the above object, there is provided a method for recognizing a nearby device using distance and intimacy, including determining distances to a plurality of nearby devices based on signals for distance determination, received from the respective nearby devices; determining zones to which the respective nearby devices belong, among multiple zones, depending on the distances to the recognized respective nearby devices; requesting nearby device information from the plurality of nearby devices; recognizing the nearby devices using received nearby device information; determining intimacies with the recognized nearby devices, based on previously stored information required for intimacy determination; and displaying results of distance determination and intimacy determination to a user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the results of recognizing a nearby device using distance and intimacy according to an embodiment of the present invention;

FIG. 2 is a configuration diagram showing an apparatus for recognizing a nearby device using distance and intimacy according to an embodiment of the present invention; and

FIG. 3 is a flowchart showing a method for recognizing a nearby device using distance and intimacy according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

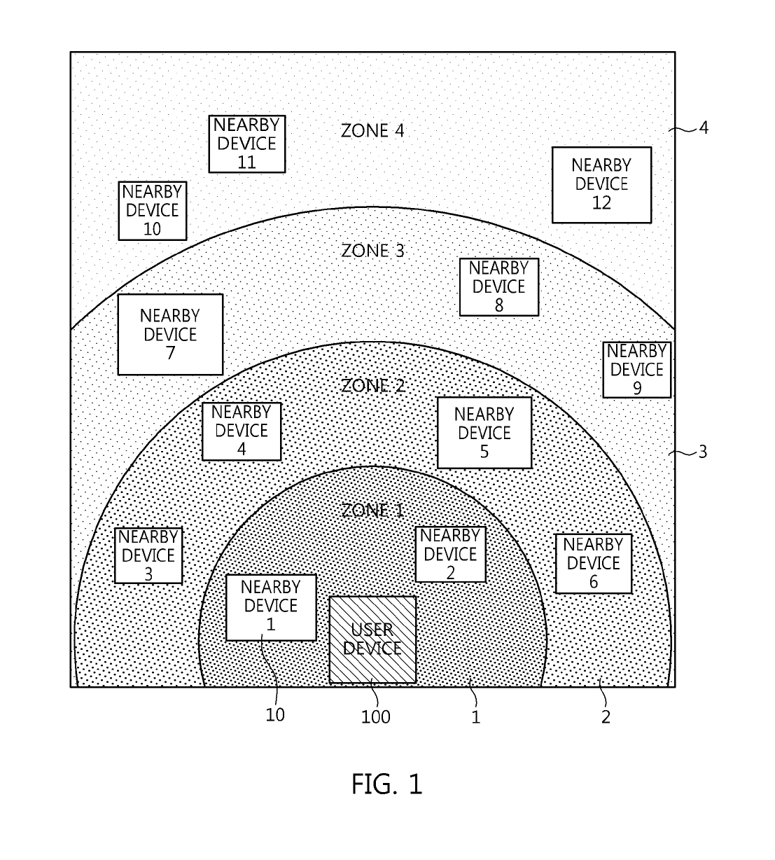

FIG. 1 is a diagram illustrating the results of recognizing a nearby device using distance and intimacy according to an embodiment of the present invention.

In the embodiment of the present invention, a user device 100 may determine distances to nearby devices 10, calculate intimacies with the nearby devices 10, and display the distances and the intimacies to a user.

That is, as shown in FIG. 1, there may be multiple zones 1, 2, 3, and 4 depending on distances from the user device 100. For example, the multiple zones 1, 2, 3, and 4 may be arranged differently depending on the distances from the user device 100. In FIG. 1, the ranges of radiuses of the multiple zones 1, 2, 3, and 4 are shown as being differently allocated. The user device 100 may determine distances to the nearby devices 10, determine zones in which the respective nearby devices are present, among the multiple zones 1, 2, 3, and 4, and display the determined zones to the user.

Further, the present invention may determine intimacies between the user device 100 and the nearby devices 10, represent the nearby devices 10 by different colors or by different sizes depending on the intimacies, and display the colors or sizes so that the user may easily know the intimacies between the user device 100 and the nearby devices 10.

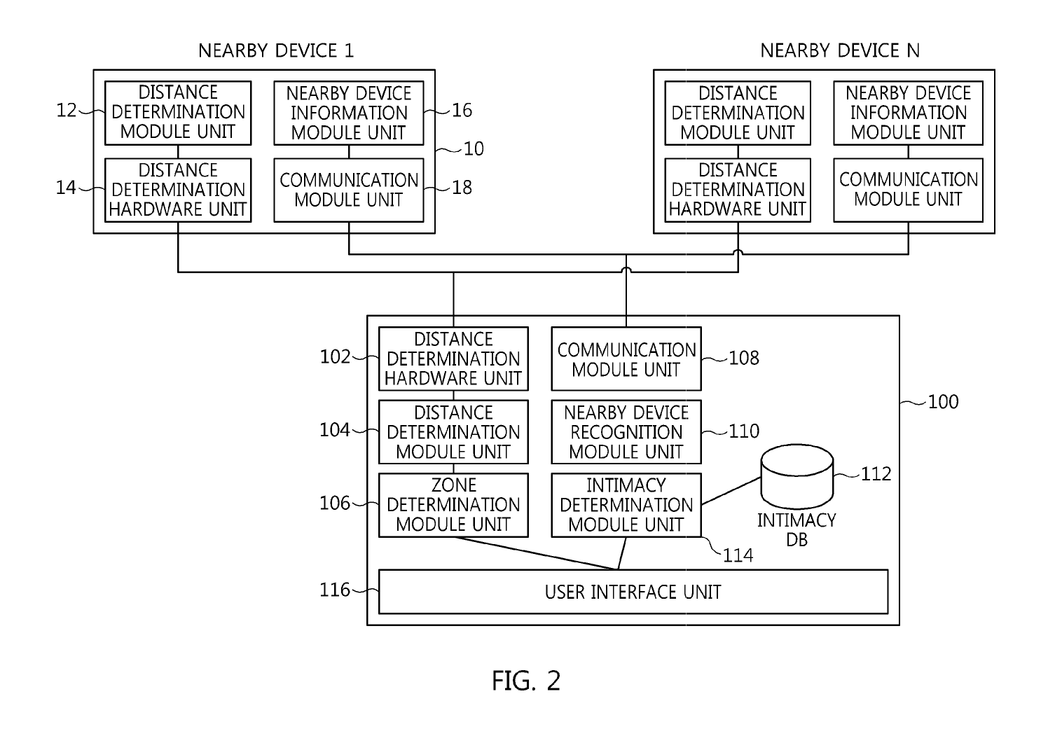

FIG. 2 is a configuration diagram showing an apparatus for recognizing a nearby device using distance and intimacy according to an embodiment of the present invention. The user device 100, which will be described later, may be regarded as an example of the nearby device recognition apparatus.

The user device 100 includes a distance determination hardware unit 102, a distance determination module unit 104, a zone determination module unit 106, a communication module unit 108, a nearby device recognition module unit 110, an intimacy database (DB) 112, an intimacy determination module unit 114, and a user interface unit 116.

The distance determination hardware unit 102 may receive signals required for distance determination from a plurality of nearby devices 10. Here, the signals required for distance determination may be any of various wireless signals such as WLAN, Bluetooth, Zigbee, RFID, and ultrasonic signals that are typically used to determine distances between devices. The distance determination hardware unit 102 may be regarded as a receiving unit.

The signals required for distance determination are periodically or non-periodically generated by the respective nearby devices.

The distance determination module unit 104 determines distances to the respective nearby devices using the information received from the distance determination hardware unit 102. Here, the distance determination module unit 104 may determine the distances to the nearby devices 10 using a typically employed method that determines distances between devices. Meanwhile, in addition to the typically employed method that determines distances between devices, methods to be developed in the future may also be applied to distance determination.

The zone determination module unit 106 determines a zone to which the corresponding nearby device 10 belongs, among the multiple zones, depending on the distances to the nearby devices 10 determined by the distance determination module unit 104.

In order to determine intimacies, the communication module unit 108 receives the information of the nearby devices 10. Here, the information of the nearby devices 10 may include, for example, the name of the owner of each nearby device 10, the type and identification number of each nearby device 10, etc.

The nearby device recognition module unit 110 may recognize each nearby device 10 using the information of the nearby devices 10 received by the communication module unit 108. In other words, the nearby device recognition module unit 110 may request nearby device information from each nearby device 10 through the communication module unit 108. Thereafter, the nearby device recognition module unit 110 may recognize the corresponding nearby device 10 based on the nearby device information received from each nearby device 10 through the communication module unit 108.

The intimacy DB 112 stores information required for intimacy determination. Here, the information required for intimacy determination may include, for example, family relationship information or friend relationship information between the user (that is, the owner of the user device 100) and the owner of the corresponding nearby device 10; communication history information between the user device 100 and the nearby device 10 (information enabling the number of calls between the devices to be detected); etc.

The information stored in the intimacy DB 112 may be periodically or non-periodically updated.

The intimacy determination module unit 114 determines the intimacy with each nearby device 10 recognized by the nearby device recognition module unit 110. That is, the intimacy determination module unit 114 has therein a predetermined algorithm capable of calculating intimacies and may calculate the intimacies of the user device 100 with the nearby devices 10 based on the algorithm.

The user interface unit 116 displays the results of distance determination and intimacy determination to the user.

In the above description, although the distance determination hardware unit 102 and the communication module unit 108 are described as being separate components, they may be integrated into a single module.

Meanwhile, in FIG. 2, the nearby device 10 includes a distance determination module unit 12, a distance determination hardware unit 14, a nearby device information module unit 16, and a communication module unit 18.

The distance determination module unit 12 transmits signals required for distance determination either periodically or as necessary. Here, as described above, the signals required for distance determination may be any of various wireless signals, such as WLAN, Bluetooth, Zigbee, RFID, and ultrasonic signals typically used to determine distances between devices.

The distance determination hardware unit 14 may transmit the signals required for distance determination, received from the distance determination module unit 12, to the user device 100. Here, the distance determination hardware unit 14 may be regarded as a transmitting unit.

The nearby device information module unit 16 provides information allowing the user device 100 to determine intimacies. Here, the term “information enabling intimacies to be detected” may be regarded as the information of the above-described corresponding nearby device 10. Consequently, the nearby device information module unit 16 may provide information such as family relationship information or friend relationship information between the owner of the nearby device 10 and the user (that is, the owner of the user device 100) and communication history information between the user device 100 and the nearby device 10 (information enabling the number of calls between the devices to be detected).

The communication module unit 18 may transmit information received from the nearby device information module unit 16 to the user device 100.

In the above description, although the distance determination hardware unit 14 and the communication module unit 18 have been described as being separate components, they may be integrated into a single module.

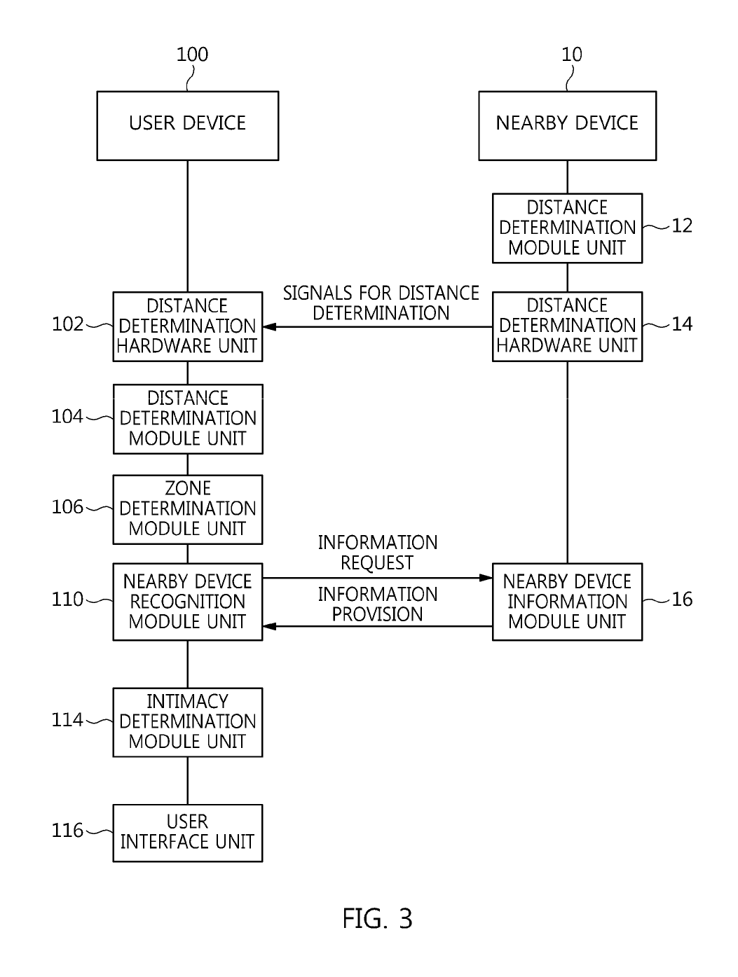

FIG. 3 is a flowchart showing a method for recognizing a nearby device using distance and intimacy according to an embodiment of the present invention.

The nearby device 10 controls the transmission of signals required for distance determination (distance determination signals) so that another device (that is, the user device 100) may determine a distance through the distance determination module unit 12 either periodically or as necessary.

Accordingly, the distance determination hardware unit 14 of the nearby device 10 transmits signals required for distance determination to the user device 100 under the control of the distance determination module unit 12.

Then, the distance determination hardware unit 102 of the user device 100 that received the transmitted signals transfers the information of the received signals to the distance determination module unit 104 of the user device 100.

Thereafter, the distance determination module unit 104 determines a distance between the user device 100 and the nearby device 10, based on the received signals required for distance determination, and transfers the determined distance to the zone determination module unit 106.

The zone determination module unit 106 determines a zone to which the nearby device 10 belongs, among multiple zones, using the distance information determined by the distance determination module unit 104.

Meanwhile, the nearby device recognition module unit 110 of the user device 100 requests the information of the nearby device 10 from the nearby device 10 through the communication module unit 108 so as to determine an intimacy with the nearby device 10.

The nearby device information module unit 16 of the nearby device 10 that received the information request provides its own information to the user device 100 through the communication module unit 18.

The nearby device recognition module unit 110 of the user device 100, which received the information of the nearby device 10 through the communication module unit 108, transfers the received nearby device information to the intimacy determination module unit 114.

Accordingly, the intimacy determination module unit 114 determines an intimacy with the nearby device 10 using the intimacy DB 112 in which information usable for intimacy determination is stored.

As a result, the user interface unit 116 may effectively display the zone determined via distance determination, and the results of intimacy determination to the user. For example, as shown in FIG. 1, the user interface unit 116 may classify the ranges of distances between the user device 100 and nearby devices 10 into multiple zones, and may represent the nearby devices 10 by icons, text, or the like in the determined zones. Further, the intimacies with the nearby devices 10 are displayed so that the user may easily know the intimacies with the nearby devices 10 by using a method of representing the nearby devices 10 by different colors or by different sizes depending on the determined intimacies.

As a result, the user device 100 effectively displays intimacies with the nearby devices 10 as well as distances from the nearby devices 10, thus allowing the user to determine which nearby devices are present in given zones, and know how reliable the nearby devices are, based on the intimacies.

In accordance with the present invention having the above configuration, distances to nearby devices and intimacies with the nearby devices are determined and are effectively displayed to the user, thus allowing the user to know how far the nearby devices are from the user device and how reliable the nearby devices are.

Therefore, there is an advantage in that the user may intuitively know which tasks can be performed using nearby devices and which nearby devices can be used to perform specific tasks.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Those skilled in the art will appreciate that various modifications and other equivalent embodiments are possible from the embodiments. Therefore, the technical scope of the present invention should be defined by the technical spirit of the claims.

1. An apparatus for recognizing a nearby device, comprising:
a distance determination module unit for determining distances to a plurality of nearby devices based on signals for distance determination, received from the respective nearby devices;
a zone determination module unit for determining zones to which the respective nearby devices belong, among multiple zones, depending on the distances to the respective nearby devices determined by the distance determination module unit;
a nearby device recognition module unit for recognizing the nearby devices using received information of the nearby devices;
an intimacy determination module unit for determining intimacies with the nearby devices recognized by the nearby device recognition module unit, based on previously stored information required for intimacy determination; and
a user interface unit for displaying results of distance determination and intimacy determination to a user,
wherein the intimacy with the nearby device indicates how reliable the nearby device is.

2. The apparatus of claim 1, wherein the user interface unit classifies ranges of distances to the respective nearby devices into multiple zones and represents the nearby devices by icons or text in the determined zones.

3. The apparatus of claim 2, wherein the user interface unit represents the nearby devices by different colors or by different sizes depending on the determined intimacies.

4. The apparatus of claim 1, wherein the multiple zones are arranged to cover ranges of different radiuses depending on distances from the nearby device recognition apparatus.

5. The apparatus of claim 1, wherein the distance determination module unit periodically or non-periodically receives signals for distance determination from the plurality of nearby devices.

6. The apparatus of claim 1, wherein the received information of the nearby devices includes a name of an owner of each nearby device, a type of the nearby device, and an identification number of the nearby device.

7. The apparatus of claim 1, wherein the information required for intimacy determination includes family relationship information or friend relationship information between an owner of the nearby device recognition apparatus and an owner of each nearby device, and communication history information between the nearby device recognition apparatus and the nearby device.

8. The apparatus of claim 1, further comprising an intimacy database (DB) for storing the information required for intimacy determination.

9. A method for recognizing a nearby device, comprising:
determining, by a distance determination module unit, distances to a plurality of nearby devices based on signals for distance determination, received from the respective nearby devices;
determining, by a zone determination module unit, zones to which the respective nearby devices belong, among multiple zones, depending on the distances to the recognized respective nearby devices;
requesting, by a nearby device recognition module unit, nearby device information from the plurality of nearby devices;
recognizing, by the nearby device recognition module unit, the nearby devices using received nearby device information;
determining, by an intimacy determination module unit, intimacies with the recognized nearby devices, based on previously stored information required for intimacy determination; and
displaying, by a user interface unit, results of distance determination and intimacy determination to a user,
wherein the intimacies with the nearby devices indicate how reliable the nearby devices are.

10. The method of claim 9, wherein displaying the results to the user comprises classifying ranges of distances to the respective nearby devices into multiple zones, and representing the nearby devices by icons or text in the determined zones.

11. The method of claim 10, wherein displaying the results to the user comprises representing the nearby devices by different colors or by different sizes depending on the determined intimacies.

12. The method of claim 9, wherein the multiple zones are arranged to cover ranges of different radiuses depending on distances from a nearby device recognition apparatus.

13. The method of claim 9, where determining the distances to the nearby devices comprises periodically or non-periodically receiving signals for distance determination from the plurality of nearby devices.

14. The method of claim 9, wherein the received information of the nearby devices includes a name of an owner of each nearby device, a type of the nearby device, and an identification number of the nearby device.

15. The method of claim 9, wherein the information required for intimacy determination includes family relationship information or friend relationship information between an owner of a nearby device recognition apparatus and an owner of each nearby device, and communication history information between the nearby device recognition apparatus and the nearby device.
